(19) United States
(12) Patent Application Publication
(10) Pub. No.: US 2019/0088944 A1
(43) Pub. Date: Mar. 21, 2019

(54) METHOD FOR PREPARING A CATHODE ACTIVE MATERIAL AND SODIUM ION BATTERY COMPRISING THE SAME

(71) Applicants: Nafiseh Yazdi Hassanzadeh, Tehran (IR); Sayed Khatiboleslam Sadrnezhaad, Tehran (IR)

(72) Inventors: Nafiseh Yazdi Hassanzadeh, Tehran (IR); Sayed Khatiboleslam Sadrnezhaad, Tehran (IR)

(21) Appl. No.: 15/710,714

(22) Filed: Sep. 20, 2017

(51) Int. Cl. H01M 4/505; H01M 4/131; H01M 10/054

(52) U.S. Cl. CPC H01M 4/505; H01M 10/054; H01M 4/131

(57) ABSTRACT

Embodiments herein discloses a method for preparing an active material for cathode. The method comprises of feeding a pre-determined ratio of multiple powdered reactants into a ball mill, mixing at a pre-determined time and speed in the ball mill, and purifying the final product via dissolving in deionized water to obtain pure active cathode material. The active cathode material is sodium manganese carbonophosphate (NMCP). Said NMCP active cathode material comprises hierarchical nanostructures constituting of micron-sized secondary particles formed in turn by a myriad of needle-like primary nanoparticles with diameter of nearly 15 nm. In NMCP cathode, the close packed primary nanoparticles contain many electrochemically active sites in favor of rapid sodium ion intercalation/deintercalation, and the secondary micro-assemblies provide structural stability for enhanced cycling performance.

### BACKGROUND OF THE INVENTION

Rechargeable sodium-ion batteries (SIBS) are fascinating alternatives to Li-ion batteries (LIBs) with real benefits in terms of cost and availability of sodium resources. The energy density of a battery is the product of the battery voltage and the capacity. Significant investigations have been done on both high voltage and high capacity electrodes. However, instability of electrolytes at high voltages restricts increasing the cathode voltage and thus there is a strong motivation for discovery of high capacity cathodes.

Sodium and sodium-ion batteries have electrochemical similarity to lithium and Li-ion batteries. While the voltage of Na/Na+ is only about 300 mV less positive than Li/Li+, the Na molecular weight of about 23 g/mol is much higher than that of Li which has about 7 g/mol. Therefore, new materials for Na and Na-ion batteries must have a desirable suite of attractive qualities to justify their implementation.

Some examples of sodium cathode materials are sodium vanadium phosphate fluoride-type material, NaVPO₄F, used in sodium-ion cells and lithium sodium vanadium phosphate fluoride used in mixed lithium and sodium containing electrolytes, as well as Na₂MPO₄F (M=Fe, Mn) materials. An interesting Na battery study using NaCrO₂ was recently reported. Unique reversible Cr(III/IV) oxidation state changes were observed. However, from a practical and environmental standpoint, NaCrO₂ is difficult to handle and Cr(VI) is considered toxic.

There exists a long-felt need for a simple and effective method for preparing an active material for cathode. Further, there is also a need for a method to obtain a cathode that can be used in sodium ion batteries, which has high capacity.

### SUMMARY OF THE INVENTION

Embodiments in accordance with the present invention discloses a method for preparing active material for cathodes incorporated in a sodium ion battery. The method disclosed herein, addresses the above-mentioned need for a method, which produces the active material to use as cathode. Further, method disclosed is a mechanochemical synthesis method for fabrication of unique nanostructures required for battery electrodes.

The method disclosed in the present invention for preparing an active material for cathode in sodium ion battery comprises the following steps. In the first step, a predetermined ratio of multiple powdered reactants is fed into a ball mill. The multiple powdered reactants are mixed within the ball mill with a rotation speed of 300 rpm. The multiple powdered reactants used as starting materials are Mn(NO₃)₂.4H₂O, Na₂HPO₄.2H₂O, and Na₂CO₃.H₂O, which are ball milled for a time period between 15 minutes and 180 minutes. The preferred time to ball mill the multiple powdered reactants is about 60 minutes. In one example, the multiple powdered reactants were ball milled for at least 45 minutes to up to 90 minutes.

Further, the weight ratio of the ball to the multiple powdered reactants is 30:1. A reaction intermediate NaMnPO₄ is formed with the progress of the reaction. After the completion of the reaction, an active material is produced. The active material obtained in the above step undergoes a purification process. The end product is purified to separate the active material from by-products. The purification process further comprises dissolving the end product in deionized water under magnetic stirring. The residue is washed in deionized water, and finally dried in vacuum at 50° C. In one example, the end product is NMCP+NaNO3.

In another embodiment, a method to prepare sodium manganese carbonophosphate is disclosed. The method involves the following steps: The powdered starting materials or multiple powdered reactants used for the preparation of the sodium manganese carbonophosphate are Mn(NO₃)₂.4H₂O, Na₂HPO₄.2H₂O and Na₂CO₃.H₂O. In the first step, the said multiple powdered reactants are fed into a ball mill. The molar ratio of the said multiple powdered reactants is 2:2:3. The said multiple powdered reactants are further mixed in the ball mill for a time period between 15 minutes and 180 minutes. The mixing of the multiple powdered reactants in the ball mill is carried out at a room temperature.

To carry the reaction in the ball mill, the weight ratio of ball to the multiple powdered reactants is maintained to 30:1. The mixing of the multiple powdered reactants within the ball mill is facilitated by rotation of the ball mill with a speed of 300 rpm. A reaction intermediate NaMnPO₄ is formed with the progress of the reaction. After the completion of the reaction process, the sodium manganese carbonophosphate (NMCP) is obtained, which undergoes a purification process. The sodium manganese carbonophosphate (NMCP) is purified to remove the by-products from the (NMCP). The purification process further comprises dissolving the end product in deionized water under magnetic stirring to obtain a residue. The residue is washed in deionized water, and finally dried in vacuum oven at 50° C.

In an embodiment, a method for preparing a cathode incorporated in a sodium ion battery is disclosed. The method according to the present invention comprises pre-treating a nanoparticle sized active material having hierarchical structure formed by uniformly mixing of multiple powdered reactants in a ball mill at pre-determined time and speed. The multiple powdered reactants fed into the ball mill are Mn(NO₃)₂.4H₂O, Na₂HPO₄.2H₂O and Na₂CO₃.H₂O. The active material used for preparing the cathode is Na₃MnCO₃PO₄. The active material is mixed with a carbon conductive material, and a binder to form a slurry in a weight ratio of 70:20:10. The slurry is coated on an aluminium foil, and further dried inside the vacuum oven overnight. After drying, circular pellets of 12 mm diameter are cut for use as cathode. The cathode obtained by the disclosed method has a specific capacity of 126 mAh/g at C/100 rate. Further, the capacity retention of the cathode after 15 cycles is 71%.

One aspect of the present invention is directed to a method for preparing an active cathode material incorporated in a sodium ion battery, the method comprising: (a) feeding a pre-determined ratio of multiple powdered reactants into a ball mill; (b) mixing of said multiple reactants at a pre-determined time and speed in the ball mill to obtain the active cathode material; and (c) purifying the obtained active cathode material. In one embodiment, the active cathode material is Na3MnCO3PO4.

In one embodiment, the multiple powdered reactants fed into the ball mill are Mn(NO3)2.4H2O, Na2HPO4.2H2O, and Na2CO3.H2O. In another embodiment, the molar ratio of the multiple powdered reactants is 2:2:3. In one embodiment, the multiple powdered reactants fed into the ball mill are Mn(NO3)2.4H2O, Na2HPO4.2H2O, and Na2CO3.H2O, at a molar ration of 2:2:3, respectively. In one embodiment, the method further comprises a ball to powdered reactant weight ratio in the ball mill of 30:1.

In one embodiment, the multiple powdered reactants are mixed in the ball mill with a rotation speed of 300 rpm. In another embodiment, the multiple powdered reactants are mixed in the ball mill for a time period between 15 minutes and 180 minutes. In another embodiment, the multiple powdered reactants are mixed in the ball mill for a time period of 60 minutes. In one embodiment, a reaction intermediate NaMnPO4 is formed while mixing the multiple reactants at a pre-determined time and speed in the ball mill to obtain the active cathode material. In one embodiment, the purifying step of the method further comprises dissolving the end product in deionized water under magnetic stirring to obtain a residue; washing the residue in deionized water; and drying the residue in vacuum oven.

Another aspect of the present disclosure is directed to a method for preparing a cathode incorporated in a sodium ion battery, said method comprising: (a) pre-treating an active material formed by uniformly mixing of multiple powdered reactants in a ball mill at pre-determined time and speed; (b) mixing the active material with a carbon conductive material and a binder to form a slurry; (c) coating the slurry on an aluminium foil; and (d) drying the coated slurry to obtain a cathode.

In one embodiment, the multiple powdered reactants fed into the ball mill are Mn(NO3)2.4H2O, Na2HPO4.2H2O, and Na2CO3.H2O. In one embodiment, the active material is Na3MnCO3PO4. In one embodiment, the weight ratio of the active material, the carbon conductive material and the binder is 70:20:10. In another embodiment, the carbon conductive material is super P. In another embodiment, the binder is carboxymethyl cellulose. In another embodiment, the capacity retention of the cathode after 15 cycles is 71%.

Another aspect of the present disclosure is directed to a method of preparing sodium manganese carbonophosphate (NMCP), the method comprising: (a) feeding a pre-determined ratio of multiple powdered reactants into a ball mill; wherein the reactants comprise Mn(NO3)2.4H2O, Na2HPO4.2H2O, and Na2CO3.H2O; (b) mixing of said multiple reactants at a pre-determined time and speed in the ball mill to obtain the sodium manganese carbonophosphate (NMCP); and purifying the obtained product. In a related embodiment, the purifying step further comprises dissolving the end product in deionized water under magnetic stirring to obtain a residue; washing the residue in deionized water; and drying the residue in vacuum oven. In one embodiment, the molar ratio of the multiple powdered reactants is 2:2:3.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein

FIG. 1 exemplarily illustrates a method for preparing an active material for cathode in a sodium ion battery;

FIG. 2 illustrates a method for preparing cathode using said active material incorporated in a sodium ion battery;

FIG. 3A illustrates XRD patterns for the active material of the present invention before dissolution in deionized water;

FIG. 3B illustrates XRD patterns for the active material of the present invention after dissolution in deionized water;

FIG. 4 is FESEM images of NMCP samples prepared after ball milling for two time intervals: (a, c) 60 min, and (b, d) 180 min;

FIG. 5 is the first-cycle charge-discharge profile of NMCP cathode at C/100 rate between 2.0 and 4.4 V; and

FIG. 6 shows the cyclic performance of the NMCP cathode measured at C/30 rate.

### DETAILED DESCRIPTION

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention generally relates to an active cathode material for sodium ion battery. More specifically, the present invention relates to a method for preparing an active material for use as the cathode in the sodium ion battery using a ball mill technique.

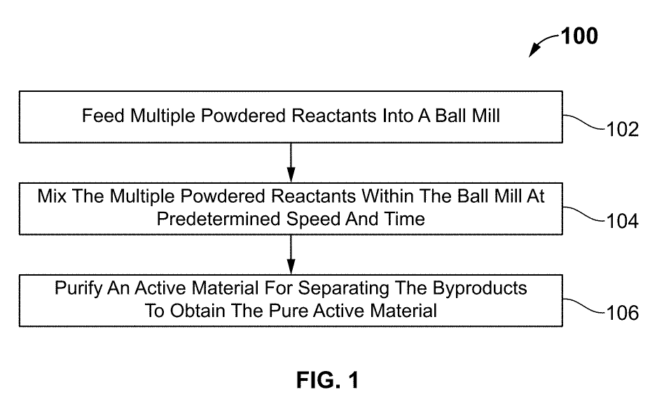

FIG. 1 exemplarily illustrates a method 100 for preparing an active material for cathode in a sodium ion battery. In an embodiment, the method 100 at step 102 comprising, multiple powdered reactants are fed into a ball mill. At step 104, the multiple powdered reactants received in the ball mill are mixed at a predetermined speed. In one embodiment, the multiple powdered reactants are ball milled for a specified time. At step 106, by-products obtained in the reaction process are separated from active material by the purification process to obtain the pure active material.

In an embodiment, the multiple powdered reactants used for preparing the active material are Mn(NO₃)₂.4H₂O, Na₂HPO₄.2H₂O, and Na₂CO₃.H₂O. The molar ratio of the multiple powdered reactants is 2:2:3. The multiple powdered reactants for producing the active material is not limited to the aforementioned reactants. In some embodiments, the reactants may be any alternatives that function and react in the same manner as the reactants disclosed in the present invention.

In an embodiment, the starting materials or the multiple powdered reactants could be other soluble salts, which provide Na, Mn, CO₃⁻² or PO₄⁻³ to the reaction, other than the salts listed above. The molar ratio of the starting materials could be varied accordingly. In one embodiment, the weight ratio of the ball to the multiple powdered reactants is 30:1.

In one embodiment, the multiple powdered reactants are mixed in the ball mill at a predetermined speed. The predetermined rotation speed is 300 rpm.

In an embodiment, the multiple powdered reactants are mixed in the ball mill for a time period between 15 minutes and 180 minutes. The particle size of the active material becomes smaller with longer milling times. However, prolonging milling time can result in particle agglomeration and formation of big secondary particles. Therefore, an optimum milling time is required to obtain desirable particle size of the active material. The optimal time period to ball mill the multiple powdered reactants is preferably 60 minutes.

In an embodiment, with the progress of the reaction a reaction intermediate is formed. The reaction intermediate formed is NaMnPO₄. The reaction intermediate reacts further to produce a final product. The final product of the present invention is the active material.

In another embodiment, the active material is sodium manganese carbonophosphate (NMCP). The chemical formula of the sodium manganese carbonophosphate (NMCP) is Na₃MnCO₃PO₄. The sodium manganese carbonophosphate (NMCP) obtained via ball mill technique has a hierarchical nanostructure. In one embodiment, the ball mill technique used in the present invention is a dry ball mill method. In one example, a dry mixing apparatus may be used, such as a V-type mixer, a W-type mixer, a ribbon mixer, or a drum mixer. In a particular example, a dry planetary ball mill was used with agate balls and cup.

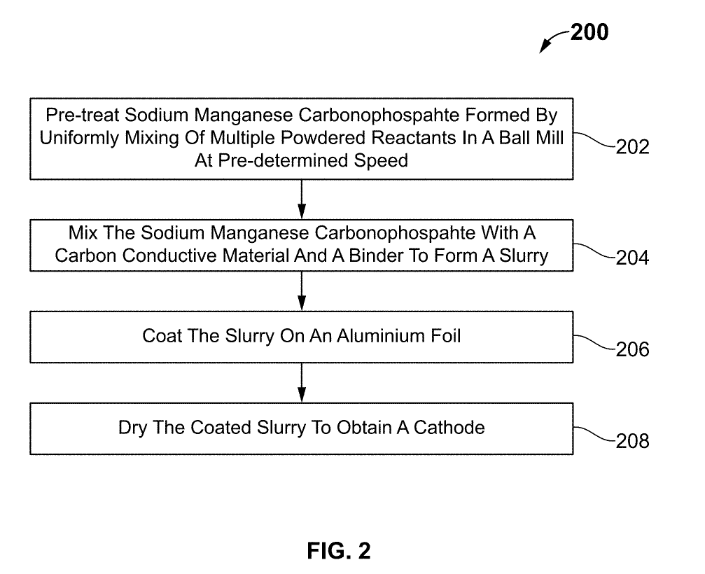

FIG. 2 illustrates a method for preparing cathode incorporated in a sodium ion battery. The method disclosed in the present invention comprises the following steps: At step 202, sodium manganese carbonophosphate formed by uniformly mixing of multiple powdered reactants is pre-treated. The pre-treated sodium manganese carbonophosphate is mixed with a carbon conductive material and a binder to form a slurry at step 204. In step 206, the slurry is coated on the aluminum foil. The coated slurry is dried to obtain a cathode at step 208. The coated slurry is dried inside the vacuum oven overnight.

In an embodiment, the weight ratio of the active material, the carbon conductive material and the binder is 70:20:10. The active material mixed in the above step is sodium manganese phosphorus carbonate (NMCP).

In another embodiment of this invention, the carbon conductive material is one or more selected from the group consisting of a polyacrylonitrile (PAN), a polyaniline (PANT), an acetylene black, a carbon black, a super P, or a poly (ethylene oxide). As used herein a “super P” is a conductive carbon black, such as for example a “Super P” material commercially available from Timcal Graphite & Carbon, Westlake, Ohio, USA.

In one embodiment, carbon conductive material used in the present invention is super P. The carbon conductive material is not limited to super P, it can be any carbon conductive material that serves the purpose of the invention. The binder used in the present invention is carboxymethyl cellulose (CMC). The binder used may be any binder, which functions similarly as carboxymethyl cellulose (CMC) to achieve the objective of the present invention.

In an embodiment, the specific capacity of the cathode disclosed in the present invention is 126 mAh/g at C/100 rate. Further, the capacity retention of the cathode after 15 cycles is 71%.

In some embodiments, ball milling is a simple and energy efficient way of applying kinetic energy to break the chemical bonding. When ball-milling technique is used for synthesizing electrode materials, an improvement in electronic conductivity can be expected due to the very fine particles and their large specific surface area nanostructures.

In another embodiment, ball milling provides homogenous mixing of the starting materials. The said technique reduces the reaction time and further increases the production rate of the active material due to the application of mechanical energy. Further, NMCP nanoparticles obtained in the present invention have hierarchical structure constituting of micron-sized secondary particles formed in turn by a myriad of needle-like primary nanoparticles with a diameter of nearly 15 nm.

The following examples are intended to illustrate certain embodiments of the present invention, but do not exemplify the full scope of the invention.

### EXAMPLES

### Example-1: XRD Pattern Study of the Active Material

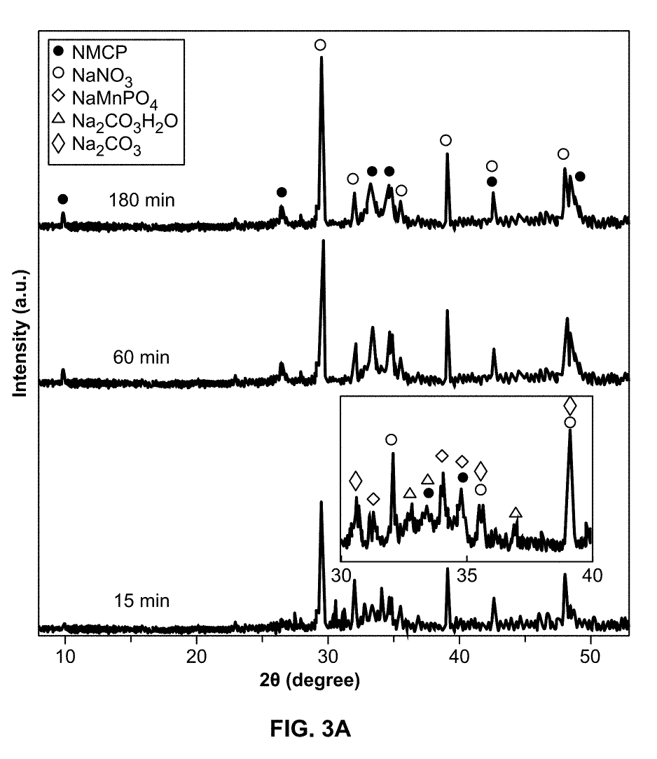

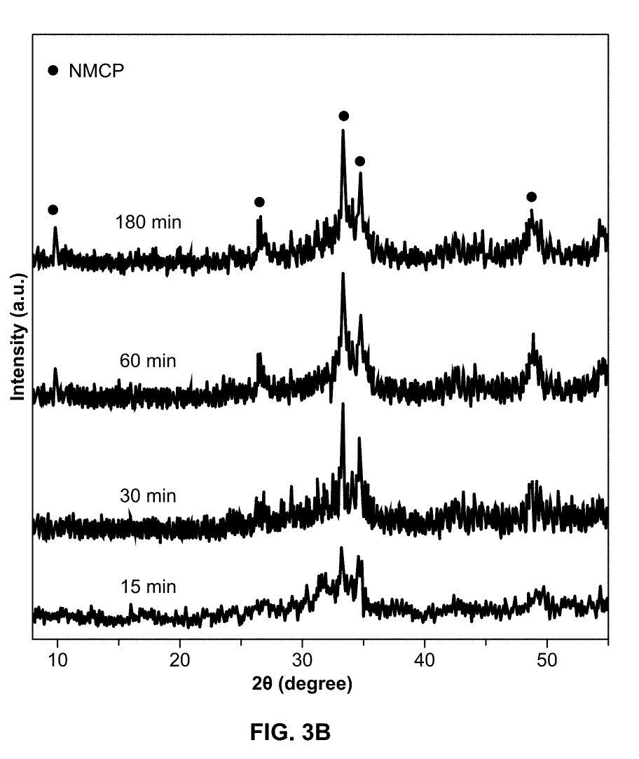

FIG. 3A illustrates XRD patterns for the active material of the present invention after ball-milling for various times, before dissolution in deionized water. FIG. 3A is a graph, representing the presence of by-products along with the active material. The XRD pattern of the active material were studied before the purification process. The product obtained at the end of the reaction comprises NMCP and NaNO3 phases in all the samples. The XRD patterns were studied after the ball mill was performed for 15 minutes, 60 minutes and 180 minutes.

From the graph, it can be depicted that, even after ball milling for 15 minutes more phases were observed in the final product including NaMnPO₄, Na₂CO₃ and unreacted Na₂CO₃.H₂O phases in addition to NMCP and NaNO₃. NaMnPO₄ formed is the reaction intermediate. The aforementioned phases diminished with increasing of the milling time. NMCP and NaNO₃ were only phases present as the milling time was increased.

FIG. 3B illustrates XRD patterns for the active material of the present invention after dissolution in deionized water. The XRD patterns of the active material after dissolution in DI water were studied. The dissolution of the final product in the deionized water removes the byproducts formed in the reaction (by products seen in FIG. 3A). In FIG. 3B, only a single-phase formation i.e. NMCP phase is observed, even after ball milling for 15 minutes and 30 minutes. However, the peaks become sharper when ball milled for 60 minutes. Further, no significant changes occur by further increasing the milling time to 180 minutes. This is an indication that the milling times above 60 minutes do not have significant effect on the NMCP phase formation.

### Example-2: Morphological Studies of the Synthesized Materials

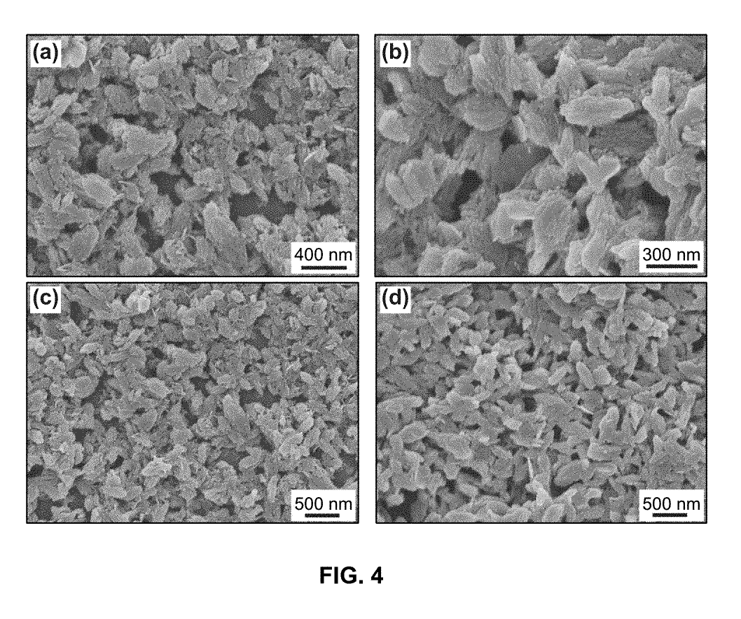

Morphological studies of the synthesized materials were performed with field emission scanning electron microscope (FESEM, JSM-6700F). FIG. 4 illustrates FESEM images of NMCP samples prepared after ball milling for two-time intervals: (a, c) 60 min, and (b, d) 180 min. From the figure, it is seen in that the FESEM images of a and b, where a and b represents samples milled for 60 minutes and 180 minutes have hierarchical nanostructures constituting of micron-sized secondary particles formed in turn by a myriad of needle-like primary nanoparticles with diameter of nearly 15 nm.

When comparing the FESEM images of a, and b, it was observed that the sample ball milled for 60 minutes have smaller secondary particle size, than the sample ball milled for 180 minutes. However, prolonging the milling time results in particle agglomeration and formation of big secondary particles as seen in FESEM images of b. Further the average size of the secondary particles prepared by ball milling for 60 minutes, and 180 minutes (c and d) are 188 nm and 236 nm, respectively. Consequently, the optimal milling duration was set to 60 minutes.

### Example-3: NMCP Test as Cathode Materials for Sodium-Ion Batteries

In this example, sodium manganese carbonophosphate (NMCP) were tested as cathode materials for sodium-ion batteries. The NMCP was mixed with carbon black and carboxymethyl cellulose (CMC) binders with a weight ratio of 70:20:10 to form a slurry. The slurry was coated on an aluminum foil, and dried under vacuum oven overnight. After drying, circular pellets of 12 mm diameter were cut out for use as the cathode. The sodium foil was cut from the sodium bulk (Sigma) and was used as the anode or counter electrode.

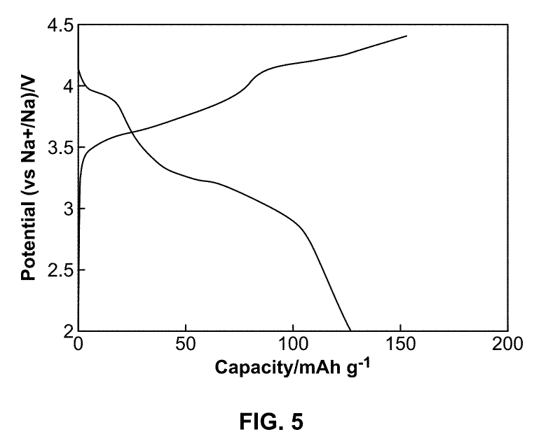

The cells were assembled in an Ar-filled glove box (MBraun Labstar) with 1 M NaPF6 in ethyl carbonate (EC)/dimethyl carbonate (DMC) with a volume ratio of 1:1 (Dodochem, China) as the electrolyte, and a piece of microglass fiber (GF/D, Whatman) as the separator. The coin cells were tested between 2.0 and 4.4 V on a battery tester (Neware CT-3008W). FIG. 5 is the first-cycle charge-discharge profile of NMCP cathode at C/100 rate between 2.0 and 4.4 V. Plateaus corresponding to the charge and discharge are clearly observable. The specific capacity of NMCP cathode is 126 mAh/g at C/100 rate. The discharge plateaus are seen at 3.9 V and 3.3 V corresponding to the Mn4+/Mn3+ and the Mn3+/Mn2+ reduction processes, respectively.

### Example-4: Performance of the NMCP Electrode

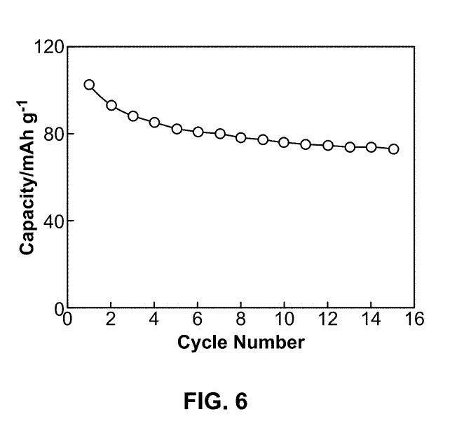

FIG. 6 shows the cyclic performance of the NMCP electrode measured at C/30 rate. From the graph, it can be depicted that, with the increase in cycles, the discharge capacity gradually decreases. The first discharge capacity for NMCP cathode is 103 mAh/g, which nearly stabilizes at around 73 mAh/g. The capacity retention of the electrode after 15 cycles is 71%. The NMCP cathode has close packed primary nanoparticles, which possess many electrochemically active sites in favor of rapid sodium ion intercalation/deintercalation. The secondary micro-assemblies provide structural stability needed for enhanced cycling performance.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention.

Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

1. A method for preparing active cathode material incorporated in a sodium ion battery, the method comprising the steps of:
(a) feeding a pre-determined ratio of multiple powdered reactants into a ball mill;
(b) mixing of said multiple reactants at a pre-determined time and speed in the ball mill to obtain the active cathode material; and
(c) purifying the obtained active cathode material.

2. The method of claim 1, wherein the active cathode material is Na₃MnCO₃PO₄.

3. The method of claim 1, wherein the multiple powdered reactants fed into the ball mill are Mn(NO₃)₂.4H₂O, Na₂HPO₄.2H₂O, and Na₂CO₃.H₂O.

4. The method of claim 1, wherein the molar ratio of the multiple powdered reactants is 2:2:3.

5. The method of claim 1, further comprises a ball to powdered reactant weight ratio in the ball mill is 30:1.

6. The method of claim 1, wherein the multiple powdered reactants are mixed in the ball mill with a rotation speed of 300 rpm.

7. The method of claim 1, wherein the multiple powdered reactants are mixed in the ball mill for a time period between 15 minutes and 180 minutes.

8. The method of claim 1, wherein the multiple powdered reactants are mixed in the ball mill for a time period of 60 minutes.

9. The method of claim 1, wherein a reaction intermediate NaMnPO4 is formed in step B.

10. The method of claim 1, wherein the purifying step further comprises:
dissolving the end product in deionized water under magnetic stirring to obtain a residue;
washing the residue in deionized water; and
drying the residue in vacuum oven.

11. A method for preparing cathode incorporated in a sodium ion battery, the method comprising the steps of:
pre-treating an active material formed by uniformly mixing of multiple powdered reactants in a ball mill at pre-determined time and speed;
mixing the active material with a carbon conductive material and a binder to form a slurry;
coating the slurry on an aluminium foil; and
drying the coated slurry to obtain a cathode.

12. The method of claim 11, wherein the multiple powdered reactants fed into the ball mill are Mn(NO₃)₂.4H₂O, Na₂HPO₄.2H₂O, and Na₂CO₃.H₂O.

13. The method of claim 11, wherein the active material is Na₃MnCO₃PO₄.

14. The method of claim 11, wherein the weight ratio of the active material, the carbon conductive material and the binder is 70:20:10.

15. The method of claim 11, wherein the carbon conductive material is super P.

16. The method of claim 11, wherein the binder is carboxymethyl cellulose.

17. The method of claim 11, wherein the capacity retention of the cathode after 15 cycles is 71%.

18. A method of preparing sodium manganese carbonophosphate (NMCP), the method comprising:
feeding a pre-determined ratio of multiple powdered reactants into a ball mill; wherein the reactants comprise Mn(NO₃)₂.4H₂O, Na₂HPO₄.2H₂O, and Na₂CO₃.H₂O;
mixing of said multiple reactants at a pre-determined time and speed in the ball mill to obtain the sodium manganese carbonophosphate (NMCP), and
purifying the obtained sodium manganese carbonophosphate (NMCP).

19. The method of claim 18, wherein the purifying step further comprises:
dissolving the end product in deionized water under magnetic stirring to obtain a residue;
washing the residue in deionized water; and
drying the residue in vacuum oven.

20. The method according to claim 18, wherein the molar ratio of the multiple powdered reactants is 2:2:3.
